(19) United States
(12) Patent Application Publication
(10) Pub. No.: US 2002/0156888 A1
(43) Pub. Date: Oct. 24, 2002

(54) Method and apparatus for detecting and reporting configuration errors in a multi-component switching fabric

(76) Inventors: Man-Ho L. Lee, Milpitas, CA (US); Marcelo M. de Azevedo, Round Rock, TX (US); Cynthia Sakaguchi, San Jose, CA (US); Farangis Aberg, Cupertino, CA (US)

Correspondence Address: OPPENHEIMER WOLFF & DONNELLY, P. O. BOX 10356, PALO ALTO, CA, 94303, US

(21) Appl. No.: 10/029,590

(22) Filed: Dec. 21, 2001

Related U.S. Application Data
(60) Provisional application No. 60/285,936, filed on Apr. 23, 2001.

(51) Int. Cl. G06F 15/173

(52) U.S. Cl. 709/224; 709/238

(57) ABSTRACT

A method of automating the verification of a fabric for interconnecting a cluster of end nodes. Switches within the fabric periodically access ports that are neighbors to ports of the switch to gather information about the neighboring port. This information is stored in the switch and is available for access by an end node fabric management process, which, after obtaining the information determines whether the information is valid, and subjects the information to a plurality of tests to determine whether the configurations of the switch and the connections made thereto are compatible and valid. If the configurations are compatible and valid, ports on the switch pertaining to the information are enabled for data transfer. If configurations are incompatible or invalid, ports on the switch are disabled.

### CROSS-REFERENCE TO RELATED APPLICATIONS

This application claims priority to prior U.S. Provisional Application, entitled “METHOD AND APPARATUS FOR DETECTING AND REPORTING CONFIGURATION ERRORS IN A MULTI-COMPONENT SWITCHING FABRIC”, filed on Apr. 23, 2001, Ser. No. 60/285,936, which application is hereby incorporated by reference into the present application.

This application incorporates by reference U.S. Provisional Application, entitled “METHOD AND PROTOCOL TO ASSURE SYNCHRONOUS ACCESS TO CRITICAL FACILITIES IN A MULTI-SYSTEM CLUSTER”, filed on Apr. 23, 2001, Ser. No. 60/286,053, into the present application.

This application is related to U.S. Application entitled “A CLUSTERED COMPUTER SYSTEM AND A METHOD OF FORMING AND CONTROLING THE CLUSTERED COMPUTER SYSTEM”, filed on Aug. 22, 2000, Ser. No. 09/935,440, which application is hereby incorporated by reference into the present application.

This application is related to U.S. Application entitled “METHOD AND APPARATUS FOR DISCOVERING COMPUTER SYSTEMS IN A DISTRIBUTED MULTI-SYSTEM CLUSTER”, filed on Aug. 31, 2001, Ser. No. 09/945,083, which application is hereby incorporated by reference into the present application.

### FIELD OF THE INVENTION

The present invention relates generally to a computerized method for detecting and reporting configuration errors in a multi-component switching fabric. The invention relates more specifically to detecting whether the hardware components of a switching fabric that interconnects multiple end nodes are validly connected, configured, functioning and compatible with each other, and reporting any detected configuration errors.

### DESCRIPTION OF THE RELATED ART

FIG. 1 shows a system setting in which the present invention operates. The system setting includes a plurality of end nodes 10-40 in a cluster configuration interconnected by an external high-speed switching fabric. Each end node 10-40 is typically a server having one or more processor units interconnected by an internal high-speed fabric (not shown). In one embodiment, a server has 16 processor units. The internal high-speed switching fabric includes routers and links. Routers have the function of routing packets from a source processor unit or I/O device to a destination processor unit or I/O device. In another embodiment, two internal high-speed switching fabrics, for fault tolerance, interconnect the processor units and I/O devices.

The external high-speed switching fabric provides direct connectivity between end nodes 10-40 in the cluster by routing packets between processor units (and possibly I/O devices) in different end nodes. Each end node in the cluster has a unique end node number, depending on its location in the cluster topology. In some configurations, two external fabrics, for fault tolerance, interconnect the end nodes of the cluster. Each external fabric comprises one or more switches 42, 44 and links 46a-h, 48a-h connecting the switches 42, 44 to the end nodes 10-40.

While it is preferable that all of the end nodes in the cluster are of the same type, this is not essential to the present invention. The present invention is operative in heterogeneous environments as long as the participating end nodes provide the required elements and logic to cooperatively implement the invention. Also, the present invention is applicable to end nodes having a single processor unit. Furthermore, the invention is operative in a variety of different types of fabrics, such as ServerNet (from Compaq Computer Corporation) or Infiniband. The only requirement is that the interconnect logically separate data traffic from management traffic. U.S. Pat. No. 5,751,932, issued to Horst, et al., discusses the ServerNet architecture and is hereby incorporated by reference into the present application.

An external fabric usually includes a plurality of interconnected components because of the number of end nodes to be interconnected by the external fabric. For example, if a single switch 42, 44 has only 12 ports and it is desired that an external fabric connect sixteen end nodes, then more than one switch is needed. Other requirements, such as bandwidth and allowance for future expansion of a cluster, may dictate that two or more switches be used in the external fabric. One such arrangement is a split-star topology which has two switches 42, 44 per external fabric. Each switch 42, 44 is a boundary switch because it has direct connections to the end nodes 10-40. In this configuration, half of the end nodes 10-24 connect to one switch 42 and half of the end nodes 26-40 connect to the other switch 44. The two switches are interconnected to each other over a set of links 50 so that one half, nodes 10-24, can communicate with the other half, nodes 26-40, and each switch 42, 44 is given a position ID. In one implementation, the switch ports are numbered from 0 through 11, with ports 0-7 being reserved for connectivity to end nodes and ports 8-11 being reserved for connectivity to one or more other switches. The end nodes that are connected to the switch 42 having position ID 1 have a node number equal to the port number to which the end node is connected plus 1. The end nodes that are connected to the switch 44 having position ID 2 have a node number equal to the port number to which the end node is connected plus 9. Between the two switches 42, 44, ports 8-11 of one switch connect to ports 8-11, respectively, of the other switch.

Typically, an instance of a FABric MANagement Process (referred to as FABMAN in FIG. 1) runs in each end node. In one embodiment of the current invention, the fabric management process is responsible for verifying that the external fabrics are correctly configured. In the system setting, shown in FIG. 1, a management console 52a-h, 54a-h is available for each end node (only four are shown). An operator, from a management console at any end node, can issue commands or examine a report or log file to verify the cluster configuration.

When a large number of components is needed to construct an external fabric, there are many ways to interconnect the components and some of these ways lead to configurations that can cause the cluster to fail to operate properly. Failure can occur because hardware, firmware, or configuration files in the switches making up the fabric is not compatible across all of the switches (despite the switches being correctly connected as far as the physical topology is concerned), or because the switches are not connected correctly, or both. Failures are not restricted to occurring during the first installation of the cluster. Failures may also develop and affect an operational cluster during procedures such as replacing failed switches or links, scaling the cluster by adding more switches or end nodes, reconfiguring the cluster topology, and installing newer versions of hardware, firmware, or configuration files in the switches.

Some of the requirements in the external fabric for proper functionality are the following:

(a) each port of a switch that connects to an end node must be compatible with the port in the end node;

(b) each port of a switch that connects to another switch must be compatible with the port in the other switch;

(c) cables interconnecting the end nodes or switches must be connected properly, i.e. no loose, incorrect, or missing connections;

(d) each port must connect to an end node or switch in the same fabric;

(e) firmware running on each of the switches must be compatible; and

(f) the proper configuration files must be downloaded to the switches.

It is clear that if any one of the above conditions is not met, the external fabric can cause the cluster to malfunction or to crash. Currently, it appears that there is no mechanism available to an operator to safely ensure that the external fabric is correctly configured. A problem with an external fabric configuration may only be found when data traffic is moving through ports, connections, or switches that are improperly configured or incompatible with each other. Thus, there is a need for a method that checks the configuration of a fabric to ensure that it is properly connected, and enables data traffic on switch ports only after proper checks have passed. The present invention is directed towards such a need.

### BRIEF SUMMARY OF THE INVENTION

A method in accordance with one embodiment of the present invention is a method of verifying the configuration of a switching fabric that interconnects a plurality of end nodes into a cluster, where the switching fabric includes at least one switch and a plurality of links, each interconnected end node having a fabric management process, and each switch having a plurality of ports. The method includes the steps of obtaining, from the switch, stored information, gathered by the switch, saving the stored information so as to be accessible to the fabric management process and determining from the stored information whether or not a link is connected to any one of the switch ports. The method further includes, for each switch port having a link connected thereto, determining whether the stored information gathered by the switch and pertaining to the switch port is valid and for each switch port for which the gathered information is determined to be valid, performing a plurality of tests on the gathered information pertaining to the switch port. If the gathered information pertaining to the switch port passes each test in at least a subset of the plurality of tests, the switch port is enabled for data traffic, otherwise, the switch port is disabled for data traffic.

An apparatus in accordance with the present invention is an end node interconnected by a switching fabric to a plurality of other end nodes of a cluster, the switching fabric including at least one switch and a plurality of links, and each switch having a plurality of ports, where the end node comprises (i) one or more processing units, each unit having a processor and a memory; and (ii) at least one port for connecting one or more processing units to the switching fabric. The memory of at least one of the processing units of each end node contains a fabric management process that is configured to: obtain, from the switch, stored information and save the stored information so as to be accessible to the fabric management process, where the stored information is gathered by the switch; determine, from the stored information, whether or not a link is connected to any one of the switch ports; determine, for each switch port having a link connected thereto, whether the stored information gathered by the switch and pertaining to the switch port is valid; perform, for each switch port for which the gathered information is determined to be valid, a plurality of tests on the gathered information pertaining to the switch port; enable the switch port for data traffic, if the gathered information pertaining to the switch port passes each test in at least a subset of the plurality of tests, and disable the switch port for data traffic, otherwise.

The fabric management process in the end node obtains, from the switch, stored information, each time a recurring, prescribed interval has lapsed. In one version of the invention, the interval is about 60 to 180 seconds.

The end node hardware delivers an interrupt to the fabric management process whenever a link alive state transition occurs on a port that connects the end node to a direct neighbor switch. The fabric management process records an event to a log whenever it receives a link alive state transition interrupt. If the interrupt indicates that link alive is now present on the port, the fabric management process obtains, from the switch, stored information and carries out neighbor checks on the stored information. This is done to expedite gathering neighbor information (i.e., the fabric management process does not need to wait for the next periodic time interval to send a request to the switch).

In one version of the invention, the memory in which the fabric management process resides is the same memory in which the information obtained from the switch is saved.

Another apparatus, in accordance with the present invention, is a switch which includes a plurality of ports, each configured to be connected to a port of another switch or port of an end node in a cluster, and routing hardware for routing packets from any of the plurality of switch ports to any other of the plurality of switch ports, where the routing hardware includes selective routing hardware control logic for enabling or disabling the transfer of data packets on each of the plurality of ports. The switch further includes link alive hardware logic configured to allow the end nodes and switches to determine whether or not a port is connected to a live link, an interval timer for repeatedly timing a scan interval and indicating the expiration thereof, and a first memory having a program resident therein that includes a routine that is operative, upon the expiration of the scan interval, to: (i) select, in turn, each one of the plurality of ports; (ii) determine, for each selected port, whether or not a gather info flag is set; and (iii) for each selected port connected to a live link and having the gather info flag set, construct a ‘gather neighbor info request’, send the constructed request over each selected port, and receive and store any response from any port connected to each selected port. The program further includes a routine that is operative to return, upon request, via one of the plurality of ports, all stored responses. Also included in the switch is a processor connected to the first memory, for executing programs resident in the first memory and a second memory having a configuration file resident therein, wherein the configuration file includes a routing table that specifies how packets are to be routed between the plurality of ports.

Additionally, the switch has an internal port configured to transfer fabric management packets and the selective routing hardware control logic is further configured to keep the internal port enabled for transferring of fabric management packets to and from any of the other switch ports, including ports that are disabled for data traffic.

In one embodiment of the switch, the link alive hardware logic resides in each of said plurality of ports and the link alive hardware logic is configured to allow the end nodes and switches to determine whether or not a port is connected to a live link by periodically sending and detecting the presence of a “keep-alive” symbol.

The program resident in the first memory of the switch is further operative, upon the switch detecting return of link alive on a port, to (i) determine, for said port, whether or not a gather info flag is set; (ii) if the gather info flag is set for said port, construct a ‘gather neighbor info request’, send the constructed request over said port, and receive and store any response from any port connected to said port.

The program in the first memory of the switch is further operative, upon the switch being powered on, or upon the switch receiving a hard reset command from an operator, to disable all switch ports for data traffic and further operative, upon the switch detecting a loss of link alive on a port, to disable said port for data traffic.

The program resident in the first memory of the switch is further operative, after the switch is powered on or when the switch receives a hard reset command from an operator, and after the ports are disabled, to (i) select, in turn, each one of said plurality of ports, (ii) determine, for each selected port, whether or not a gather info flag is set; and (iii) for each selected port connected to a live link and for which the gather info flag is set, construct a ‘gather neighbor info request’, send the constructed request over each said selected port, and receive and store any response from any port connected to each said selected port.

The configuration file, in one embodiment of the present invention, in the second memory of the switch further includes data parameters for each port that specify expected neighbor data values to be returned by a device connected to each particular port.

One advantage of the present invention is that in large cluster configurations, incorrectly configured cluster fabrics can be identified very quickly.

Another advantage is that an effective mechanism is provided to a participating end node to detect and report incompatible firmware and configuration files stored in a switch.

Yet another advantage of the present invention is that an end node connected to the switching fabric periodically monitors the health of the connections in the fabric. This allows transient problems to be detected.

Still another advantage of the present invention is that data traffic is disabled when a problematic link is discovered (for example, when loss of link alive occurs or when neighbor checks for the port connected to the link fail). Data traffic is also conservatively disabled in all switch ports when a switch is powered on or receives a hard reset command from an operator. Conversely, data traffic on a switch port is enabled only after neighbor checks for the port have passed. This prevents potentially serious problems in the fabric, including data corruption, packet looping due to incorrect cabling and illegal fabric configurations, and fabric deadlocks.

Yet another advantage is that the present invention disallows cross-fabric connections which can potentially lead to faults in one fabric propagating to the other fabric, consequently defeating the goal of fault tolerance for the cluster.

Yet another advantage is that an operator, from a console at any end node, can issue commands or examine a report or log file to be assured that the connections in the cluster are correct, that the firmware running on the switches has the proper version and that the correct configuration files are downloaded to each switch.

### BRIEF DESCRIPTION OF THE DRAWINGS

These and other features, aspects and advantages of the present invention will become better understood with regard to the following description, appended claims, and accompanying drawings where:

FIG. 1 shows a system setting in which the present invention operates;

FIGS. 2A-B show a flow chart for carrying out the “gather neighbor information” operation in a switch.

FIG. 3 shows a data structure for the information collected by a switch for a port from the port's neighbor; and

FIGS. 4A-D show a flow chart of one aspect of the present invention.

### DETAILED DESCRIPTION OF THE INVENTION

Implementation of the present invention requires that functionality be added to the end nodes in the cluster and to the switches in the fabric. Each has a cooperative role to play in carrying out the present invention.

Each end node has an external fabric management process, as described below.

Each switch of the present invention has the following elements:

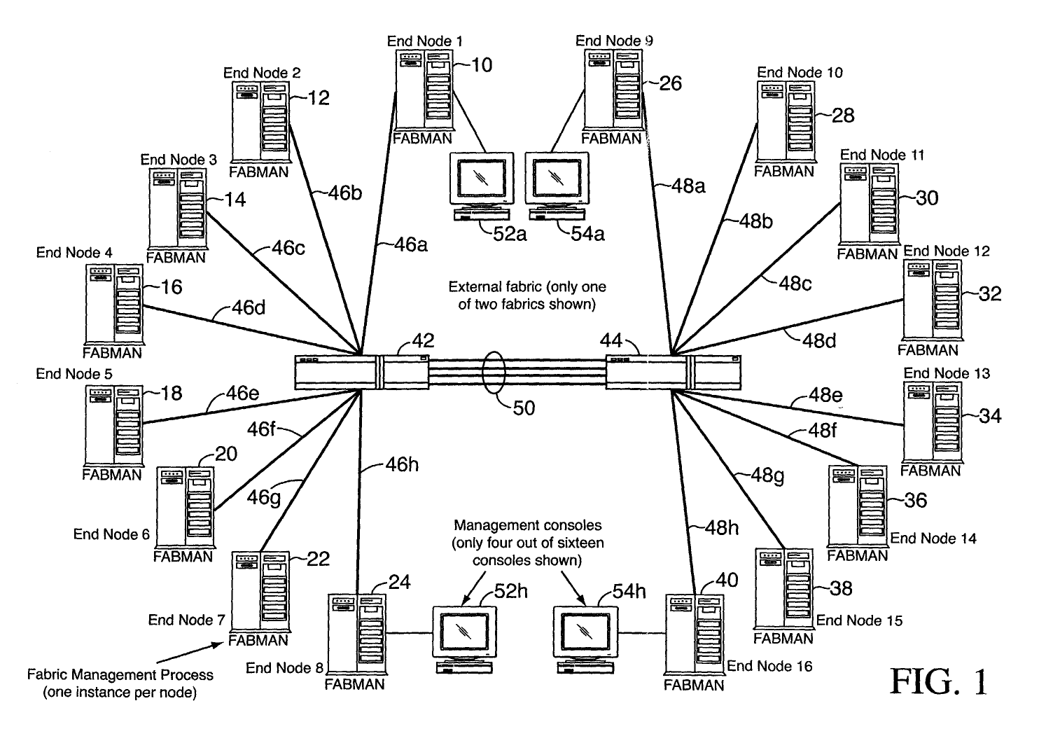

(a) physical hardware that performs the hardware functions of the switch and includes a fixed number of ports. A switch 42, 44 in FIG. 1, typically, has 12 ports, but the present invention is not restricted to any particular number of ports. Data can enter the switch from any port and be routed to any output port according to the content of a destination field of the packet being routed;

(b) switch firmware that gives the switch a set of predefined functions that include gathering information from port neighbors and returning information to an end node, upon request. The firmware file is downloaded to the switch and includes the function of collecting data from each port periodically and reporting the data to a requester; and

(c) a configuration file that specifies how packets are routed in the switch. The configuration file is downloaded to the switch and defines the routing information of the switch and the initial values of programmable attributes of the switch.

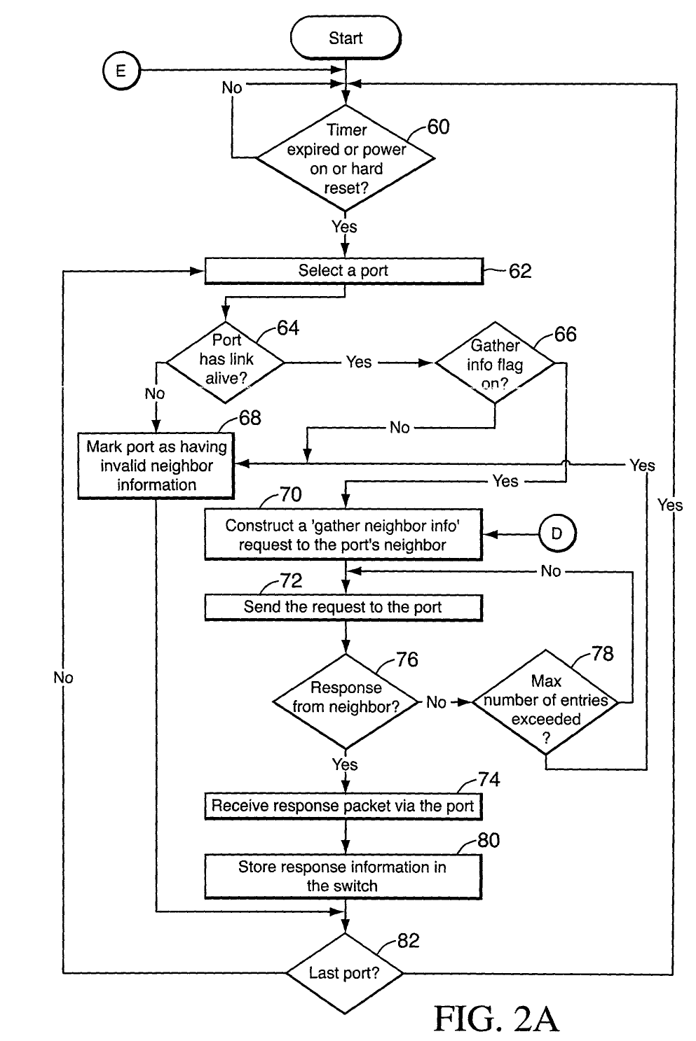

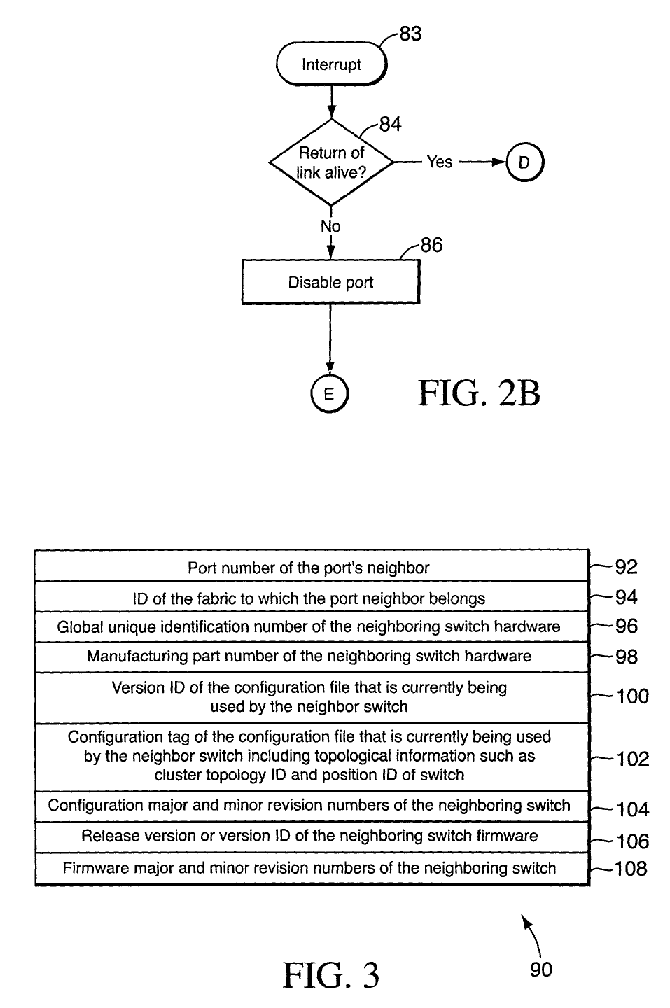

FIGS. 2A-B show a flow chart for carrying out the “gather neighbor information” operation by the switch. The switch first tests to determine whether a timer has lapsed, in step 60. The timer sets the cycle time of the “gather neighbor information” routine. A preferred value for the cycle is about 30 to 60 seconds. Next, the switch selects, in step 62, one of its ports and determines whether link alive is present on that port (which indicates that the port is connected to another device such as an end node or another switch), in step 64. If not, the port is marked as having invalid neighbor information, in step 68, and the next port, if any are left as determined by step 82, is selected, in step 62. If step 64 indicates that link alive is present on the port, the switch determines, in step 66, if a ‘gather info’ flag is set for the port. If not, the port is marked as having invalid neighbor information, in step 68, and the next port, if any are left as determined by step 82, is selected, in step 62. If so, the switch proceeds to construct a “gather neighbor info” request to the port's neighbor, in step 70, and then send the request, in step 72, to the port's neighbor. Upon receiving the request, the port's neighbor retrieves the necessary data from a variety of data structures and builds a response packet. The switch receives the response packet, in step 74, and stores it internally, in step 80; otherwise, if a response packet is not received after a certain number of “gather neighbor info” requests are sent via the port, as determined in steps 76 and 78, the port is marked, in step 68, as having invalid neighbor information. Finally, the switch determines whether the current port is the last port, in step 82. If not, the switch selects the next port, in step 62. If so, the switch waits for the time to next expire, in step 60. The main purpose of the above steps is to keep a switch updated about the identity of the neighboring components, so that, when called upon by a fabric managing process, the switch can return up-to-date information.

The periodic actions described above are also performed after the switch is powered on or after it receives a reset command from an operator (for example, a reset command is typically issued by the operator after a new configuration file is downloaded to the switch), as shown in step 60. This is intended to expedite gathering neighbor information after switch initialization (i.e., the switch does not need to wait for the next periodic time interval to elapse immediately after initialization). By default, all switch ports are disabled for data traffic upon power on or reset.

The switch hardware generates an interrupt to the switch firmware whenever a link alive state transition occurs on a port. If the interrupt, in step 83 of FIG. 2B, indicates that link alive is now present on a port, as determined in step 84, the switch will immediately send, in steps 70 and 72, a “gather neighbor info” request on that port to expedite gathering neighbor information (i.e., the switch does not need to wait for the next periodic time interval to send the request). If the interrupt indicates loss of link alive on a port, the port is automatically disabled, in step 86, for data traffic. (More details about the “keep alive” protocol used in ServerNet links can be found in U.S. Pat. No. 5,574,849, which patent is hereby incorporated by reference into the present application.)

The data 90 collected by the switch for a port from the port's neighbor is set forth in FIG. 3. The data includes but is not limited to,: the port number of the port's neighbor 92, the id of the fabric to which the port neighbor belongs 94, a global unique identification (GUID) number of the neighboring switch hardware 96, a manufacturing part number of the neighboring switch hardware 98, a version ID of the switch configuration file that is currently being used by the neighbor switch 100, a configuration tag of the switch configuration file that is currently being used by the neighbor switch including topological information such as a cluster topology ID and the position ID of the switch in said cluster topology 102, configuration major and minor revision numbers of the neighboring switch 104, a release version or version ID of the neighboring switch firmware 106, and firmware major and minor revision numbers of the neighboring switch 108. This information is used by the external fabric management process to determine the validity of a port connection in accordance with the present invention.

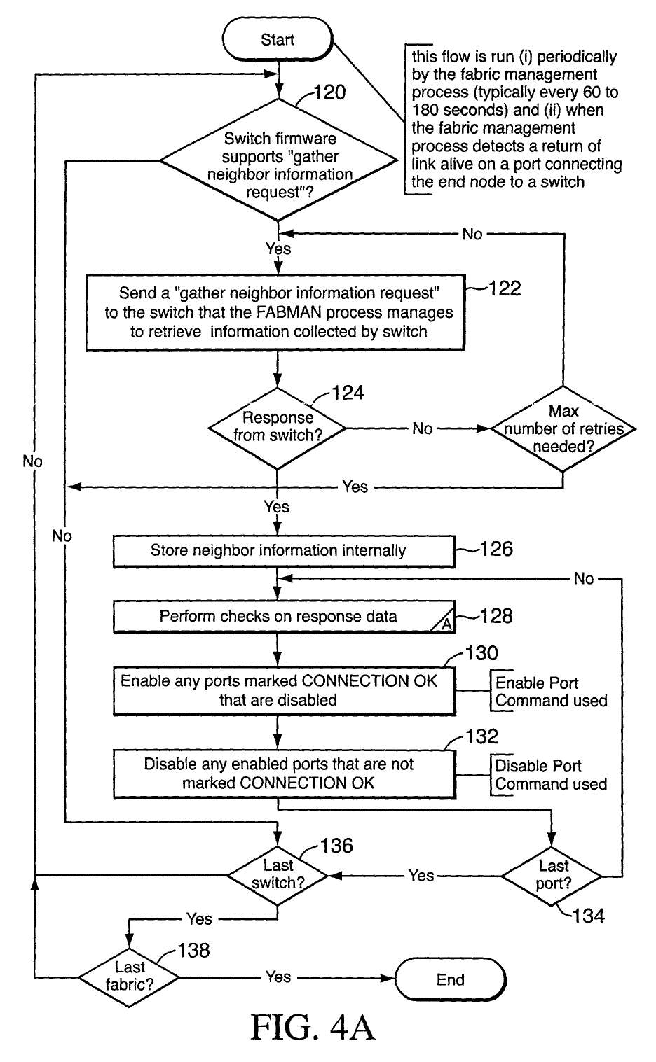

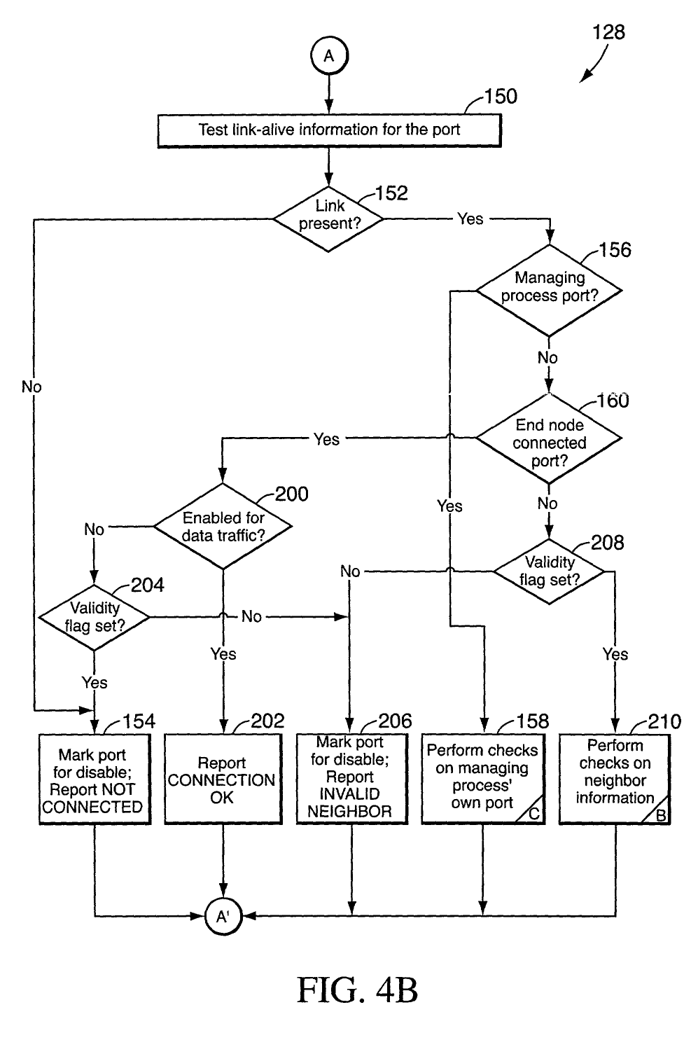

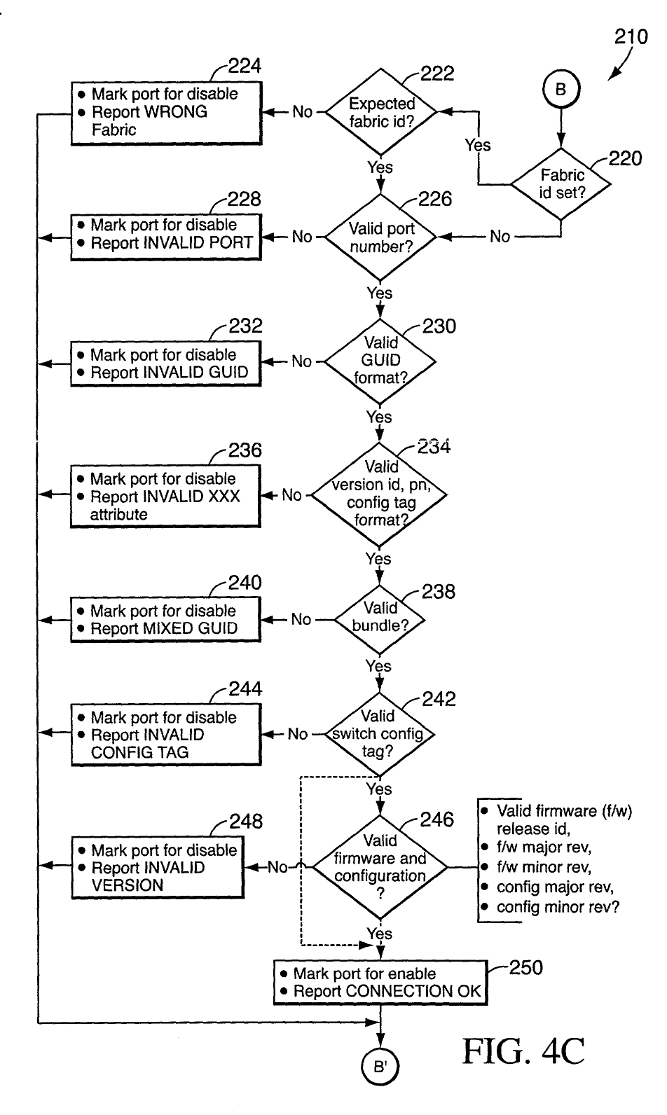

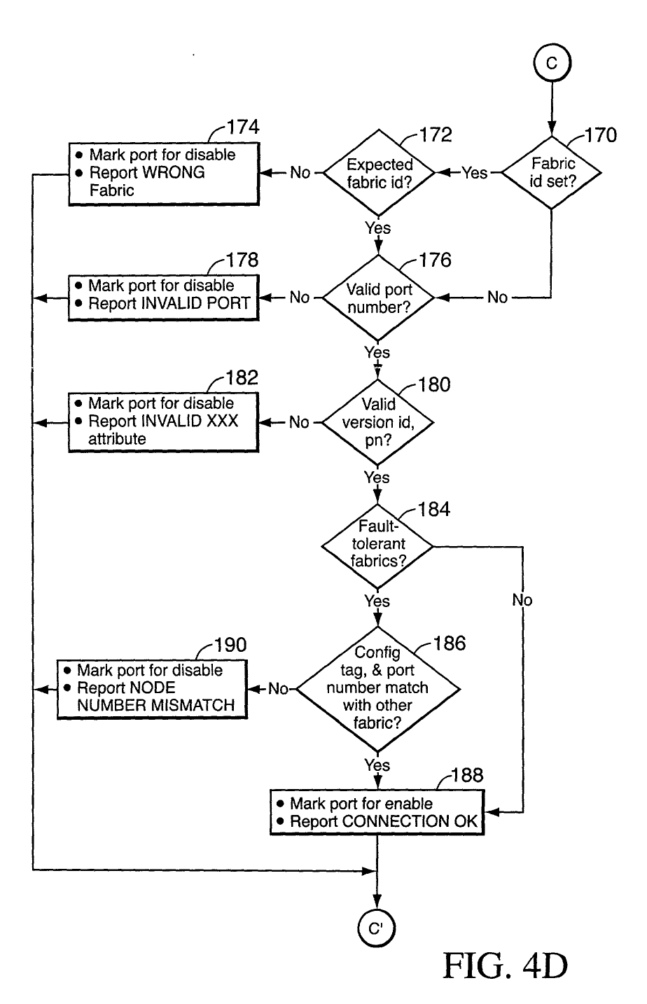

FIGS. 4A-D show a flow chart of one aspect of the present invention. Preferably, the external fabric management process in each end node carries out the steps set forth in FIGS. 4A-D.

A switch is typically managed by a plurality of fabric management processes, each of which runs on an end node directly connected to that switch. The management role among the fabric management processes is distributed and egalitarian, without any of the processes assuming a specialized or mastership function. All of the fabric management processes implement the same algorithmic steps to check the external fabrics, and consequently have identical information as to whether each of the ports of a switch should be enabled or disabled for data traffic. This distributed management model offers a number of advantages. First, it avoids the additional complexity of an election algorithm to select a master fabric management process; such an algorithm would have included a mechanism to detect failures of the master fabric management process and elect a new master in the event of failures. Second, it gives the operator the ability to verify the external fabric configuration (including checking for configuration errors) from any of the end nodes. This provision ensures more than just convenience to the operator. In fact, it may prove critical for availability of the entire cluster by ensuring that problems are promptly reported by all end nodes, and service actions and repairs can be initiated from any end node without potential delays or difficulties associated with logging on to a particular end node. Third, it ensures that the fabric management functionality is fault-tolerant. Namely, fabric management is still possible from other end nodes despite the failure of a fabric management process or perhaps even the failure of an entire end node. Fourth, it ensures that the external fabric can still be managed despite certain failures that can impair a particular fabric management process from performing its role. For example, if the link connecting an end node to a switch fails, fabric management functions are still performed from other end nodes connected to that same switch.

The external fabric management process, in FIG. 4A, periodically sends out a gather neighbor information request, in step 122, to the switch that the management process manages, assuming that the switch firmware supports this request, as determined in step 120. A preferred value for the cycle to send this request to the switch is about 60 to 180 seconds. When the switch responds, as determined in step 124, the information previously gathered by the switch is stored by the management process, in step 126. Next, the management process performs a series of checks, in step 128, as described in Detail A in FIG. 4B, on the data received for each port managed by the management process. If, after the checks have been made, a CONNECTION OK status is returned for a port (which indicates that the checks passed), and if the port is disabled, the port is then enabled for data transfer, in step 130. If, after the checks have been made, a CONNECTION OK status is not returned for a port (which indicates that the checks failed), and if the port is enabled, the port is then disabled for data transfer, in step 132. The fabric management process repeats this process for each port of each switch of each fabric under its management, as determined in steps 134, 136, 138.

If a large topology includes a switch that is not an immediate neighbor of any end node, the present invention is implemented with additional support in the switch firmware to forward “gather neighbor information” requests generated by the fabric management process(es) to the remote switch, and subsequently forward the responses returned by the remote switch back to the fabric management process(es).

FIG. 4B, Detail A, shows the checking process 128 for each port. First, link-alive information for the port is tested, in step 150. If link alive is not present, as determined in step 152, then the port is marked for disable, in step 154, and the management process reports, also in step 154, that the link is not connected for the current port and goes on to the next port. If the link is present, as determined in step 152, and the port is connected to the end node on which the management process is running, as determined in step 156, the management process performs, in step 158, a limited set of tests, as described in Detail C, FIG. 4D, including verifying that the direct neighbor switch reports, in step 172, a correct fabric id, if the fabric id is set, as determined in step 170, a valid port number belonging to the subset of port numbers reserved to end node connections, in step 176, a valid configuration version id, and a valid manufacturing part number, in step 180. In a fault-tolerant implementation of this invention, as determined in step 184, the management process will typically also verify, in step 186, that the configuration tag and port number reported by a direct neighbor switch are identical to the configuration tag and port number reported by a direct neighbor switch on the other fabric. This latter check is important in system settings for which is important to ensure that an end node is assigned the same node number on both external fabrics (this allows an end node to have an identical identity on both fabrics, which simplifies inter-node communications and packet routing between end nodes in the cluster). The node number is determined from the boundary topological position the end node connects to an external fabric. Said boundary topological position is uniquely determined by the configuration tag and port number of the switch the end node connects to. If the checks performed by the management process on the port directly connected to the end node pass, the port is marked for enable, in step 188, and the process goes on to the next port. If any of the checks performed by the management process on the port directly connected to the end node fail, then the port is marked for disable, and the proper error is reported, in steps 174, 178, 182, 190.

If the port is expected to be connected to a different end node from the end node on which the management process is running, as determined in step 160, by testing the port number, the management process checks, in step 200, if the port has already been enabled by the management process instance running on that end node. If yes, this port has previously been enabled for data traffic, and it is reported, in step 202, as CONNECTION OK. Otherwise, a validity flag is consulted, in step 204, to determine whether the neighbor information is valid. . If the validity flag is on, the port is marked for disable and reported as NOT CONNECTED, in step 154, as only the end node connected to that port has authority to enable said port. If the validity flag is off, the port is marked for disable and reported as INVALID NEIGHBOR, in step 206, and the connection should be considered one of the following:

(i) the port is connected to a non-compatible switch that is not able to perform the Gather Port Neighbor Information as requested;

(ii) the port is connected to an end node that is not compatible or not initialized; or

(iii) the port is connected to other non-compatible entity that does not respond to the Gather Port Neighbor Information as requested.

If the port is expected to be connected to another switch, as determined in step 160, the validity flag is consulted, in step 208, to determine whether there is valid neighbor information. If the information is not valid, then the port is marked for disable and reported as INVALID NEIGHBOR, in step 206. If the validity flag indicates valid neighbor information, in step 208, then the management process performs additional checks, in step 210, on the neighbor information, as indicated by detail B.

FIG. 4C sets forth the steps of detail B. In this process, the information gathered by the switch, by its periodic ‘Gather Neighbor Info’ requests, is tested.

Because there can be more than one fabric in the external interconnect that forms the cluster and because a port cannot be a member of more than one fabric, the fabric id must be checked, in step 222, to determine whether the neighboring port is connected to a switch in the correct fabric. First, a test is made, in step 220, to determine whether the fabric id is set. If the fabric id is set, then the fabric id is tested, in step 222. If the fabric id is not set, checking the gathered information continues, because there is insufficient evidence to reject a connection at this point. If the fabric id is incorrect, then the port is marked for disable and WRONG FABRIC is reported for the port, in step 224.

Next, in step 226, the port number is tested. The switches in the external fabrics can be designed to be connected in a specific way. For example, the port connections between switches may be specified. In one implementation, if there are two switches and ports of each are numbered from 0 to 11, it is preferred that ports 8-11 of the first switch connect to ports 8-11 of the second switch in the same fabric. If the neighbor data indicates that the neighbor port does not have a valid port number, as determined in step 226, the port is marked for disable and INVALID PORT is reported, in step 228.

Following this, the switch global unique identification (GUID) number format is tested, in step 230, by the fabric managing process. The GUID is a unique identification number that is assigned to each switch at the time the switch is manufactured; no two switches ever have the same GUID. If the neighbor data indicates that the GUID does not have a valid format, the port is marked for disable and reported as INVALID GUID, in step 232.

The configuration version id, manufacturing part number and configuration tag format of the neighboring switch are next checked, in step 234. If any of these values are found to have an invalid format, the port is marked for disable and reported, in step 236, as INVALID xxx ATTRIBUTE, where xxx is the name of the attribute.

The connections between switches in an external fabric can be bundled together to provide more aggregate bandwidth and higher availability for connections between end nodes. For those connections in the same bundle, the management process checks to make sure that the other end of each connection is connected to the same entity. For example, the GUIDs of ports 8-11 are expected to have the same value if connected, because each of these four connections is considered to be in the same bundle. If there is any mismatch, in step 238, the port is marked for disable and reported as MIXED GUID, in step 240. In one implementation of the management process, the logic reports all ports that are involved in the mismatch. In another implementation, the logic reports all ports except the first port, as ports involved in the mismatch, using the first port as a reference port for comparison. In the latter implementation, the order of checking is specified.

The configuration tag is used to uniquely specify a cluster topology ID and the position ID of a switch in the specified cluster topology. The cluster topology ID uniquely identifies the type of topology used to connect the switches in the external fabric. One such topology is the split-star configuration described above and shown in FIG. 1. In that topology, the switch 42 that is connected to end nodes 1-8 has the position ID of 1 and the other switch 44 has a position ID of 2. A switch is informed in advance of its position in the assumed topology via static routing information in the configuration file. This is preferred so that the processing power of the switch is not used for dynamic updating and spreading of routing information. The configuration tag cannot be duplicated in an external fabric. Thus, if the two switches in a split-star configuration have the same configuration tag, as determined in step 242, the port on which the error is noticed is marked for disable and reported as INVALID CONFIG TAG, in step 244.

Additional steps can be performed to check for a compatible version of the configuration file and firmware running on a neighbor switch. These steps verify, in step 246, that the major and minor revisions of the configuration file loaded on the neighbor switch are equal or higher than certain specified levels. Similarly, the release version, major and minor revisions of the firmware running on the neighbor switch are verified, in step 246, to ensure that they are equal or higher than certain specified levels. If either an incompatible configuration file or incompatible firmware is detected on the neighbor switch, the port in which the error is noticed is marked for disable and reported, in step 248, as INVALID VERSION. These additional steps are typically not required if strict compatibility requirements are observed whenever new firmware and configuration file versions are created. Although it may be feasible to ensure compatibility between all firmware and configuration file versions during a limited number of releases, strict compatibility requirements tend be very difficult or even unfeasible for products with a life span of several years. Often, ensuring backward and forward compatibility between all possible versions of firmware and configuration files over several years tends to severely restrict the development of new releases (technically and/or economically). Over time, technical and economical challenges for testing compatibility between all possible firmware and configuration file versions also mount. At a certain stage of the product life span, it may be preferable to discontinue compatibility to certain older versions of the firmware and configuration files. At that stage, the checks described in step 246 can be added to an implementation of the current invention to ensure compatibility between firmware and configuration files stored in neighboring switches.

If at least a subset of each of the above checks passes, the port is marked for enable and is reported as CONNECTION OK, in step 250. As described above, ports marked with CONNECTION OK, but which are not yet enabled, are enabled for data traffic. The management process builds an Enable Port command and sends the command to the switch, in step 130 in FIG. 4A, instructing the switch to enable the specified port for data traffic. Otherwise, if the port is marked for disable, but for any reason was found enabled for data traffic, it is disabled, in step 132 in FIG. 4A, by a Disable Port command.

The fabric management process records an event to a log whenever it detects that the neighbor-checks result for a switch port changed compared to the result obtained in the previous run of the neighbor-checks. The event includes the new neighbor-check result for the switch port. If the new result is not CONNECTION OK, the event may also include additional details that explain why the neighbor checks failed. The operator may examine the event log, from any end node, to identify configuration errors. The operator may also issue commands on a console, from any end node, to obtain neighbor-check status for all ports of any switch.

Although the present invention has been described in considerable detail with reference to certain preferred versions thereof, other versions are possible. In another version of this invention, the steps set forth in FIGS. 4A-D can be carried out by the firmware program resident in the switch itself. In this embodiment, the configuration file loaded in the switch memory is augmented with expected neighborhood parameters for each one of the switch ports, in addition to the routing table that controls the switch packet routing functionality. The switch firmware sends “gather neighbor info” requests in each port and compares responses obtained for these requests with expected neighborhood parameters stored in the switch configuration file according to the steps shown in FIGS. 4A-D. In this embodiment, the switch firmware has an active role in deciding whether each switch port should be enabled or disabled for data traffic, and stores in memory resident in the switch the result of the neighbor checks performed for each port. An external fabric management process is also present in this embodiment of the invention. However, the external fabric management process provides merely a passive role of retrieving and reporting the result of the neighbor checks performed for each port by the switch firmware. This gives an operator the ability to verify the external fabric configuration from an end node where the external fabric management process is running.

The steps in FIGS. 4A-D are neither processing intensive nor require substantial memory for a program that implements these steps. However, factors such as memory and processing power utilization in the end nodes versus the switches may render an embodiment preferable over the other for a particular implementation of this invention.

Therefore, the spirit and scope of the appended claims should not be limited to the description of the preferred versions contained herein.

What is claimed is:

1. A method of verifying the configuration of a switching fabric that interconnects a plurality of end nodes into a cluster, the switching fabric including at least one switch and a plurality of links, each interconnected end node having a fabric management process, each switch having a plurality of ports, the method comprising:
obtaining, from the switch, stored information and saving the stored information so as to be accessible to the fabric management process, the stored information being gathered by said switch;
determining from the stored information whether or not a link is connected to any one of said switch ports;
for each switch port having a link connected thereto, determining whether the stored information gathered by said switch and pertaining to each said switch port is valid;
for each switch port for which the gathered information is determined to be valid, performing a plurality of tests on the gathered information pertaining to each said switch port;
if the gathered information pertaining to each said switch port passes each test in at least a subset of the plurality of tests, enabling each said switch port for data traffic; and
otherwise, disabling each said switch port for data traffic.

2. A method of verifying as recited in claim 1, wherein the stored information is gathered periodically by the switch.

3. A method of verifying as recited in claim 1,
wherein any neighboring port connected to any switch port belongs to an expected fabric; and
wherein the plurality of tests on the gathered information includes a test to determine whether the neighboring port belongs to the expected fabric.

4. A method of verifying as recited in claim 1,
wherein any neighboring port connected to any switch port has an expected port number; and
wherein the plurality of tests on the gathered information includes a test to determine whether the neighboring port has the expected port number.

5. A method of verifying as recited in claim 1,
wherein any switch having a port connected to said switch port has a global unique identification (GUID) number; and
wherein the plurality of tests on the gathered information includes a test to determine whether the global unique identification of the neighboring port has a valid format.

6. A method of verifying as recited in claim 1,
wherein any switch, having a port connected to said switch port, has a configuration version id, a configuration tag and a manufacturing part number; and
wherein the plurality of tests on the gathered information includes a test to determine whether the configuration version id, configuration tag and manufacturing part number of the switch connected to said switch port have valid formats.

7. A method of verifying as recited in claim 1, wherein there is a single bundle in the switching fabric, said bundle including two or more links that interconnect neighboring switches.

8. A method of verifying as recited in claim 7,
wherein any neighboring port connected to said switch port is part of the bundle, each port in the bundle having the same GUID; and
wherein the plurality of tests on the gathered information includes a test to determine the GUID of the neighboring port connected to said switch port to determine whether the neighboring port is properly in the bundle.

9. A method of verifying as recited in claim 1, wherein there are at least two bundles in the switching fabric, each said bundle including two or more links that interconnect neighboring switches.

10. A method of verifying as recited in claim 7,
wherein any neighboring port connected to said switch port is part of the first bundle, each port in the bundle having the same GUID; and
wherein the plurality of tests on the gathered information includes a test to determine the GUID of the neighboring port connected to said switch port to determine whether the neighboring port is properly in the first bundle and not in the second bundle.

11. A method of verifying as recited in claim 1,
wherein any switch, having a port connected to said switch port, has a configuration tag to uniquely specify an expected cluster topology ID and an expected position ID of the switch therein; and
wherein the plurality of tests on the gathered information includes a test to determine from the configuration tag for the switch connected to said switch port whether the switch is configured for the expected cluster topology and is in the expected position in the cluster topology.

12. A method of verifying as recited in claim 1,
wherein any switch, having a port connected to said switch port, has a firmware release revision, firmware major revision, firmware minor revision, configuration major revision, and configuration minor revision; and
wherein the plurality of tests on the gathered information includes a test to determine whether the firmware release revision, firmware major revision, firmware minor revision, configuration major revision, and configuration minor revision of the switch connected to said switch port are equal to or higher than a minimum specified level for compatibility.

13. An end node interconnected by a switching fabric to a plurality of other end nodes of a cluster, the switching fabric including at least one switch and a plurality of links, each switch having a plurality of ports, the end node comprising;
one or more processing units, each unit having a processor and a memory; and
at least one port for connecting one or more processing units to the switching fabric;
wherein the memory of at least one of the processing units of each end node contains a fabric management process that is configured to:
obtain, from the switch, stored information and save the stored information so as to be accessible to the fabric management process, the stored information being gathered by said switch;
determine, from the stored information, whether or not a link is connected to any one of said switch ports;
determine, for each switch port having a link connected thereto, whether the stored information gathered by said switch and pertaining to each said switch port is valid;
perform, for each switch port for which the gathered information is determined to be valid, a plurality of tests on the gathered information pertaining to each said switch port;
enable, if the gathered information pertaining to each said switch port passes each test in at least a subset of the plurality of tests, each said switch port for data traffic; and
disable each said switch port for data traffic, otherwise.

14. An end node as recited in claim 13, wherein the stored information is gathered periodically by the switch.

15. An end node as recited in claim 13, wherein the fabric management process is configured to obtain, from the switch, stored information each time a recurring, prescribed interval has lapsed,

16. An end node as recited in claim 15, wherein the prescribed interval is about 60 to 180 seconds.

17. An end node as recited in claim 13, wherein the fabric management process is configured to obtain, from the switch, stored information each time the fabric management process detects that a link alive status has returned to a link that connects the end node directly to a switch.

18. A switch comprising
a plurality of ports each configured to be connected to a port of another switch or a port of an end node in a cluster;
routing hardware for routing packets from any of said plurality of switch ports to any other of said plurality of switch ports, said routing hardware including selective routing hardware control logic for enabling or disabling the transfer of data packets on each of said plurality of ports;
link alive hardware logic configured to allow the end nodes and switches to determine whether or not a port is connected to a live link;
an interval timer for repeatedly timing a scan interval and indicating the expiration thereof,
a first memory having a program resident therein that includes a routine that is operative, upon the expiration of the scan interval, to:
select, in turn, each one of said plurality of ports;
determine, for each selected port, whether or not a gather info flag is set; and
for each selected port connected to a live link and having the gather info flag set, construct a ‘gather neighbor info request’, send the constructed request over each said selected port, and receive and store any response from any port connected to each said selected port;
said program further including a routine that is operative to return, upon request, via one of said plurality of ports, all stored responses;
a processor connected to the first memory, for executing programs resident in the first memory;
a second memory having a configuration file resident therein, said configuration file including a routing table that specifies how packets are to be routed between said plurality of ports.

19. A switch as recited in claim 18, wherein the program resident in the first memory is further operative, upon the switch being powered on, or upon the switch receiving a hard reset command from an operator, to disable all switch ports for data traffic.

20. A switch as recited in claim 18, wherein the program resident in the first memory is further operative, upon the switch detecting a loss of link alive on a port, to disable said port for data traffic.

21. A switch as recited in claim 18, wherein the program resident in the first memory is further operative, immediately after the switch is powered on or when the switch receives a hard reset command from an operator, to:
select, in turn, each one of said plurality of ports;
determine, for each selected port, whether or not a gather info flag is set; and
for each selected port connected to a live link and for which the gather info flag is set, construct a ‘gather neighbor info request’, send the constructed request over each said selected port, and receive and store any response from any port connected to each said selected port.

22. A switch as recited in claim 18, wherein the program resident in the first memory is further operative, upon the switch detecting return of link alive on a port, to:
determine, for said port, whether or not a gather info flag is set;
if the gather info flag is set for said port, construct a ‘gather neighbor info request’, send the constructed request over said port, and receive and store any response from any port connected to said port.

23. A switch as recited in claim 18, wherein the configuration file in the second memory includes data parameters for each port that specify expected neighbor data values to be returned by a device connected to each particular port.

24. A switch as recited in claim 18,
further comprising an internal port configured to transfer fabric management packets; and
wherein selective routing hardware control logic is further configured to keep the internal port enabled for transferring of fabric management packets to and from any of the other switch ports, including ports that are disabled for data traffic.

25. A switch as recited in claim 18,
wherein the link alive hardware logic resides in each of said plurality of ports; and
wherein the link alive hardware logic is configured to allow the end nodes and switches to determine whether or not a port is connected to a live link by periodically sending and detecting the presence of a “keep-alive” symbol.

26. A switch as recited in claim 18, wherein the scan interval has a range of about 30 to 60 seconds.

27. A switch as recited in claim 18, wherein the response from said ‘gather neighbor info’ request includes the port number of any neighboring switch having a port connected to one of said plurality of ports.

28. A switch as recited in claim 18, wherein the response from said ‘gather neighbor info’ request includes a fabric id of any neighboring switch having a port connected to one of said plurality of ports.

29. A switch as recited in claim 18, wherein the response from said ‘gather neighbor info’ request includes a global unique identification number of any neighboring switch having a port connected to one of said plurality of ports.

30. A switch as recited in claim 18, wherein the response from said ‘gather neighbor info’ request includes a manufacturing part number of any neighboring switch having a port connected to one of said plurality of ports.

31. A switch as recited in claim 18, wherein the response from said ‘gather neighbor info’ request includes a version ID of a configuration file resident in any neighboring switch having a port connected to one of said plurality of ports.

32. A switch as recited in claim 18, wherein the response from said ‘gather neighbor info’ request includes a configuration tag of a configuration file resident in any neighboring switch having a port connected to one of said plurality of ports.

33. A switch as recited in claim 32, wherein the configuration tag encodes a cluster topology ID and a position ID indicating the position the switch occupies in the cluster topology.

34. A switch as recited in claim 18, wherein the response from said ‘gather neighbor info’ request includes a release version or version ID of a firmware program resident in any neighboring switch having a port connected to one of said plurality of ports.

35. A switch as recited in claim 18, wherein the response from said ‘gather neighbor info’ request includes major and minor revision numbers of a firmware program resident in any neighboring switch having a port connected to one of said plurality of ports.

36. A switch as recited in claim 18, wherein the response from said ‘gather neighbor info’ request includes major and minor revision numbers of a configuration file in any neighboring switch having a port connected to one of said plurality of ports.

37. A method of gathering port neighbor information in a switch having a plurality of ports, each configured to be connected to a port of another switch or port of an end node in a cluster, routing hardware for routing packets from any of said plurality of switch ports to any other of said plurality of switch ports, an interval timer for repeatedly timing a scan interval and indicating the expiration thereof, a memory having a configuration file resident therein, said configuration file including a routing table that specifies how packets are to be routed between said plurality of ports, the method comprising the steps of:
upon the expiration of the scan interval,
selecting, in turn, each one of said plurality of ports;
determining, for each selected port, whether or not the port has live link and whether or not a gather info flag is set for the port; and
for each selected port connected to a live link and having the gather info flag set, constructing a ‘gather neighbor info request’, sending the constructed request over each said selected port, and receiving and storing any response from any port connected to each said selected port; and
upon receiving a request for the stored responses, returning the stored responses via one of said plurality of ports.

38. A computer readable medium having computer-executable instructions for performing a method of verifying the configuration of a switching fabric that interconnects a plurality of end nodes into a cluster, the switching fabric including at least one switch and a plurality of links, each interconnected end node having a fabric management process, each switch having a plurality of ports, the method comprising:
obtaining, from the switch, stored information and saving the stored information so as to be accessible to the fabric management process, the stored information being gathered by said switch;
determining from the stored information whether or not a link is connected to any one of said switch ports;
for each switch port having a link connected thereto, determining whether the stored information gathered by said switch and pertaining to each said switch port is valid;
for each switch port for which the gathered information is determined to be valid, performing a plurality of tests on the gathered information pertaining to each said switch port;
if the gathered information pertaining to each said switch port passes each test in at least a subset of the plurality of tests, enabling each said switch port for data traffic; and
otherwise, disabling each said switch port for data traffic.
